(19) United States
(12) Patent Application Publication
(10) Pub. No.: US 2015/0291456 A1
(43) Pub. Date: Oct. 15, 2015

(54) ELECTRIC FIELD INDUCED SEPARATION OF COMPONENTS IN AN EMULSION

(71) Applicants: Alp T. FINDIKOGLU, Santa Fe, NM (US); LOS ALAMOS NATIONAL SECURITY, LLC, Los Alamos, NM (US)

(72) Inventor: Alp T. Findikoglu, Santa Fe, NM (US)

(21) Appl. No.: 14/434,333

(22) PCT Filed: Mar. 15, 2013
(86) PCT No.: PCT/US13/31833

§ 371 Date: Apr. 8, 2015

Related U.S. Application Data
(60) Provisional application No. 61/710,910, filed on Oct. 8, 2012.

(51) Int. Cl. C02F 1/48

(52) U.S. Cl. CPC C02F 1/48; C02F 2101/32

(57) ABSTRACT

An apparatus and method for applying electric fields at specific amplitudes, gradients, and frequencies for separating oil and water from emulsions thereof, are described. Significant reduction of water concentration in stable water-in-crude oil emulsions having high (>65%) as well as low (<3%) water-cuts has been demonstrated. The apparatus does not require pre-heating of the emulsions or addition of chemicals thereto, and can be stand-alone or functionally integrated with other processes, such as mechanical or gravitational separation technologies. The apparatus may be adapted to small-volume and narrow-space environments, such as pipes.

### CROSS-REFERENCE TO RELATED APPLICATIONS

The present application claims the benefit of United States Provisional Patent Application Number 61/710,910 for “Electric Field Induced Separation Of Components In An Emulsion” which was filed on Oct. 08, 2012, the entire content of which is hereby specifically incorporated by reference herein for all that it discloses and teaches.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to the separation of oil and water emulsions and, more particularly, to the use of electric fields at specific amplitudes, gradients and frequencies, depending on the characteristics of an emulsion, to separate water and oil therefrom.

### BACKGROUND

Removal of water from water-in-oil emulsions is an important process in oil fields and refineries. When compared to methods, such as chemical demulsification, gravity or centrifugal settling, pH adjustment, filtration, heat treatment, membrane separation, and the like, methods using electric fields are attractive because they have the potential for increasing throughput, saving space, and reducing operating costs for many water-removal applications. The use of electric fields for separating water from water-oil mixtures of crude oil was first demonstrated in 1911, and numerous studies have been conducted more than a century for optimizing the process and expanding on the original idea. However, separation processes using electric fields are not well understood, nor are they completely optimized, and the processes and their methods continue to evolve.

The use of electric fields for separating water from water-in-oil emulsions is a complex process involving intercoupled electrodynamic, hydrodynamic, and electrokinetic effects, and non-equilibrium mechanisms. The determination of the optimal conditions for a given system requires detailed knowledge and control of the process. For successful implementation of electric fields for oil-water separation, electrical energy is coupled to the system in such a manner that emulsion coalescence is enhanced, the break-up of coalesced water droplets is significantly reduced, and the undesirable coupling of electrical energy either to enlarged water droplets or the separated water phase, and other components of the heterogeneous system is carefully managed.

Previous studies have shown that electric fields may enhance the emulsion coalescence and water droplet size increase through several mechanisms, including dipole-dipole attraction, migratory coalescence due to induced or contact charges, migratory coalescence due to induced or permanent dipoles in an electric field gradient, droplet chain formation and bridging, and dielectric breakdown. Electric fields can also efficiently couple energy to water-in-oil emulsions through bulk mode oscillations or interfacial polarization effects, in which case a frequency-dependent dielectric response is expected in the medium.

### SUMMARY OF THE INVENTION

Embodiments of the present invention overcome the disadvantages and limitations of the prior art by providing an apparatus and method for separating water from oil in an emulsion thereof.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, the apparatus for separating water from oil in an emulsion hereof includes: a chamber for receiving the emulsion having an inlet port for introducing said emulsion, at least one first exit port for extracting separated oil and oil/water emulsion, and at least one second exit port for extracting separated water; at least one first electrode disposed within the chamber and in contact with the emulsion; at least one grounded, second electrode disposed within the chamber and in contact with the emulsion; a first voltage source for generating a chosen voltage having a chosen frequency in electrical communication with the at least one first electrode for producing dielectric breakdown of the emulsion; whereby a chosen electric field distribution and a chosen electric field gradient distribution are established between the at least one first electrode and the at least one second electrode effective for achieving water separation from the emulsion.

In another aspect of the present invention and in accordance with its objects and purposes, the method for separating water from oil in an emulsion hereof includes: introducing the emulsion into a chamber enclosing at least one pair of electrodes in contact with the emulsion, and having at least one port for introducing the oil/water emulsion, at least one port for removing separated water, and at least one port for removing separated oil and oil/water emulsion; applying a selected voltage at a chosen frequency between each pair of the at least one pair of electrodes such that a chosen electric field and electric field gradient effective for producing dielectric breakdown in said emulsion is produced; whereby water is separated from the oil in the emulsion; and removing the separated water and the separated oil from the chamber.

Benefits and advantages of embodiments of the present invention include, but are not limited to, providing an apparatus for separating components in an emulsion, wherein unwanted effects, such as the break-up of coalesced water droplets which agglomerate and form separated water, and the coupling of electrical energy into the separated phases are minimized. Further, unlike hydrocyclones or centrifuges that create accelerative separation forces proportional to the radius of the vessel employed, the present electric field induced separation creates separation forces that are inversely proportional to the distance between the electrodes and ground-planes, thereby providing advantages over other physical separation procedures in tight, small-volume environments, such as pipes. Spatiotemporally adjustable tuning parameters, such as frequency, electric field and electric field gradient levels in electric field induced separation, permits ready optimization routes compared to other physical separation techniques. Unlike most other electric separation methods, including electrostatic/dc, pulsed-DC, AC, dual-frequency, dual electrode, RF, and microwave, as examples, that make direct use of gravitational (gravimetric) settling due to the density differential between the separated components to increase the separation process, embodiments of the present invention use multiple forces including electric field-gradient induced forces, thereby allowing permittivity differential between the separated components to also be used to enhance separation.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a graph of the concentration as a function of frequency of applied electric field illustrating that the concentrations of separated pure oil (curve a), separated water (curve b), and separated oil with reduced water (curve c), are maximized, and the concentration of unseparated emulsion (curve d) is minimized at a frequency of˜10 MHz.

FIG. 2 is a graph of the onset of dielectric breakdown as a function of frequency for the stationary crude oil emulsion used in FIG. 1 hereof.

FIG. 3A is a schematic representation of a side view of one embodiment of the apparatus of the present invention, illustrating an embodiment of a hollow cylindrical vessel having a single, central electrode for generating electric field induced separation and electronic apparatus for supplying dc and high-frequency voltages to the vessel and for diagnostic analyses of the voltages and currents thereof, while FIG. 3B is a schematic representation of a top cross sectional view of the apparatus of FIG. 3A, hereof, illustrating the vessel and central electrode.

FIG. 4A is a schematic representation of a side view of a multielectrode embodiment of the apparatus shown in FIG. 3A, wherein the parallel internal electrodes are disposed parallel to the axis of the hollow cylindrical vessel, while FIG. 4B is a schematic representation of a top cross sectional view thereof.

FIG. 5A is a schematic representation of a side view of another multielectrode embodiment of the apparatus shown in FIG. 3A, wherein the internal electrodes are disposed perpendicular to the axis of the hollow cylindrical vessel, while FIG. 5B is a schematic representation of a top cross sectional view thereof.

FIG. 6 shows the reduction of water content in separated oil for two crude oil emulsion systems having low water cut.

### DETAILED DESCRIPTION OF THE INVENTION

Briefly, embodiments of the present invention include apparatus for separating components in an emulsion using frequency-tunable electric fields having electric field gradients combined with electrohydrodynamic separation, and oil/water phase separation and extraction. Electric field induced separation (EFIS), for both batch and flow processing of crude oil samples having different emulsion characteristics and water-cuts have been performed. For an approximately ten-fold reduction in water concentration, the present EFIS oil-water separation process for crude oil with strong water-in-oil emulsion characteristics requires between about 10 and about 100 MJ per m³ of separated-water, or between about 10 and 100 kW for processing approximately 10³ bbl of crude per day. Diagnostic probes for measuring temperature, voltage, current, conductivity, water concentration, and pressure may be included in order that frequencies and electric field strengths may be optimized for particular emulsions. As will be discussed in more detail hereinbelow, attention is given to limiting unwanted effects, such as break-up of enlarged water droplets, and coupling of electrical energy to separated water.

Optimal parameters for an effective EFIS process depend on many factors including emulsion characteristics, water concentration in the crude oil, required separation rate and efficiency, and mode of separation (for example, batch versus flow). Since there is a wide range of crude oil systems, and since crude oil characteristics may change significantly with time within a given oil well, any practical water/oil separation process needs to have the adaptability commensurate with the complexity of the crude oil system of interest. The EFIS process of the present invention has been applied to a variety of crude oil systems both in batch and flow modes, which has delineated process parameters that need to be optimized.

High frequency electric fields have been found by the present inventor to be more effective for crude oil/water separations. In general, solids and water-in-oil emulsions in crude oil have significantly larger effective dielectric constants than the oil components, and therefore the electrical energy couples more strongly to the solids and water-in-oil emulsions than to the oil components in the medium. Further, the coupling of electrical energy into the medium, especially into the water phase, increases with increasing frequency, and greater energy can be beneficially coupled to the dielectric channel that contains water-in-oil emulsions, thereby inducing further separation in the medium when the dielectric channel is electrically shunted by a low-resistance conductive channel, such as separated water with dissolved impurities; that is, high-frequency EFIS processes are more tolerant of electrical shorts.

The applied voltage and current into the vessel that contains the emulsion system determine the electric power used in the EFIS process. However, since the separation process is highly nonlinear with respect to these quantities, and strongly frequency dependent, process parameters are determined with respect to the spatiotemporal distribution of electric fields and the electric field gradients in the vessel. These parameters are related to the electrode/antenna configuration, the frequency-dependent impedance of the crude oil medium, and the extent of the oil-water separation for a given voltage input at a given frequency.

The separation process has been found to initiate at a frequency-dependent electric field level, identified as the “initiation phase.” The “dielectric breakdown” of the crude oil emulsion system at or above this electric field level is the precursor to the next phase of the process, which is identified as the “separation phase,” which may have several sub-phases with distinct characteristics. The separation process plateaus, or saturates at the “saturation phase” which depends on many factors, including the initial characteristics of the emulsion system, the manner in which the separated water phase has been managed, and the magnitude of the electric field level.

As stated hereinabove, in most other electric separation methods (electrostatic/dc, pulsed-DC, AC, dual-frequency, dual-electrode, RF, microwave, and the like), whether physical forces or heating due to electric fields, or a combination of both, are used, direct use of gravitational (gravimetric) settling of the heavy component, usually water, is implemented to improve the separation process. However, settling of small water droplets (for example, at the early stage of separation) due to gravitational force is not sufficiently rapid for many practical purposes. Further, if the medium is highly viscous, or the density differential between separated components is relatively small, phase separation may be similarly inefficient. These factors create significant challenges for electric separation of many crude oil emulsion systems, such as heavy crude oil emulsions, since they can be highly viscous and the density of the oil component can be very close to that of water. The high electric field gradients of embodiments of the present invention generate significant dielectrophoretic separation forces on the water droplets. This dielectrophoretic force is proportional to the permittivity differential between water and oil. Since the relative permittivities of crude oil is generally between 2 and 4, independent of the density of the oil, while that for water it is close to 80, the present electric field gradients induce forces which augment those from the applied electric fields for enhancing separation for such challenging emulsion systems.

Electric field gradients may also impart compressive pressure on the enlarged water droplets and the separated water phase through electrohydrodynamic forces, thereby enhancing oil-water phase separation. Further, as water emulsions and droplets enlarge due to coalescence under the influence of the oscillatory electric field, the relative importance of dielectrophoretic and gravitational sedimentation forces increases, leading to the acceleration of agglomeration of separated water. However, unless such macroscopic separated water is kept from the high electric field zones of the vessel, the separated water, which is generally conductive, may cause energy loss, and electrical shorting. Thus, the electric-field-induced coalescence of emulsions and small water droplets are optimized along with the hydrodynamic and gravity-induced sedimentation of enlarged water droplets, and the separated water phase is removed from high electric field regions of the EFIS vessel.

The overall efficiency of EFIS separation process, that is, the amount of separation per electrical energy input, depends both on the effectiveness of electric field and electric field gradient induced forces for enhancing coalescence of emulsions and small water droplets, and on the management of the loss of electric energy in the delivery and matching circuitry and in components of the crude oil system that do not directly benefit separation, such as already separated water phase. Thus, an EFIS vessel may have functional units separated in space and/or time for different phases of the EFIS process. For example, the initiation phase may require high voltages, but minimal currents; the separation phase may require modest voltages and currents at a possibly different frequency; and the saturation phase may again require large voltages and minimal current, again at a possibly different frequency. Additionally, each phase may require different hydrodynamic conditions to accommodate changing emulsion and free water phase content.

Unlike hydrocyclones or centrifuges which create accelerative separation forces proportional to the radius of the vessel, the EFIS vessel creates separation forces that are inversely proportional to the distance between electrodes and grounded electrodes. EFIS forces therefore increase, while hydrocyclonic or centrifugal forces decrease when relevant dimensions of the vessel are reduced. Thus, in tight, small-volume environments, such as pipes, the use of EFIS may be advantageous over other physical separation methods currently employed. Additionally, a range of spatiotemporally adjustable tuning parameters, such as frequency, and electric field and electric field gradient levels in the EFIS apparatus, permit on-line parameter optimization unavailable with other physical separation techniques.

Optimal EFIS process conditions may be determined theoretically, experimentally, or by a combination of both. For experimentally estimating optimal EFIS conditions, both the frequency and the amplitude of the voltage are swept between about DC into the GHz range to obtain an initial optimal frequency band and an electric field (and electric field gradient) range for a given crude oil emulsion system, a given flow rate at the input, and a given desired separation level at the output. The diagnostic probes provide real-time feedback, thereby permitting the process parameters to be tuned, as needed, in response to changes in in-flow and sampled fluid characteristics.

Separations involving crude oil samples having varying water cuts and emulsion characteristics have been investigated for both stationary reaction vessels and flow cells having associated diagnostic probes. Analyses on the process products have also been performed using inductively-coupled plasma (ICP) spectroscopy, optical microscopy, dynamic light scattering (DLS) spectroscopy, and Karl-Fischer titration.

The frequency dependence of the EFIS process was studied using a crude oil sample (IC #2, American Petroleum Institute (API) gravity of separated oil=38° , water cut=68% by weight) having significant water-in-oil emulsion characteristics, with strong and stable emulsions. A stationary mode EFIS cell (non-flowing liquid), to be described in detail hereinbelow, was employed. The experimental protocol was as follows: (i) the input voltage at a given frequency is increased until separation is initiated (“dielectric breakdown”); (ii) the vessel is maintained at that voltage, wherein the separation process advances (progression) until the separation saturates (“steady-state” is achieved); and (iii) the contents are examined and analyzed. Qualitatively, with DC excitation, some oil is separated (at the top of the vessel), but virtually no water is separated (at the bottom of the vessel). With AC excitation, however, separated quantities of both oil and water increase as the frequency increases until an optimal frequency (˜10 MHz) is reached, beyond which the separated oil quantity decreases precipitously while the separated water quantity decreases little. Similar frequency dependence may be observed for other crude oil samples, with the optimal frequency depending on characteristics of the crude oil emulsion.

Although DC or low-frequency (˜Hz to ˜kHz) electric fields may have efficient initiation of the separation process, the progression stage may be limited due to shorting within the medium. High frequency (100 s of MHz to GHz) electric fields may couple too much energy into the high dielectric constant phase of the heterogeneous system, such as water, either making the separation process inefficient, or causing re-emulsification of the medium, thereby hindering advancement of the separation process.

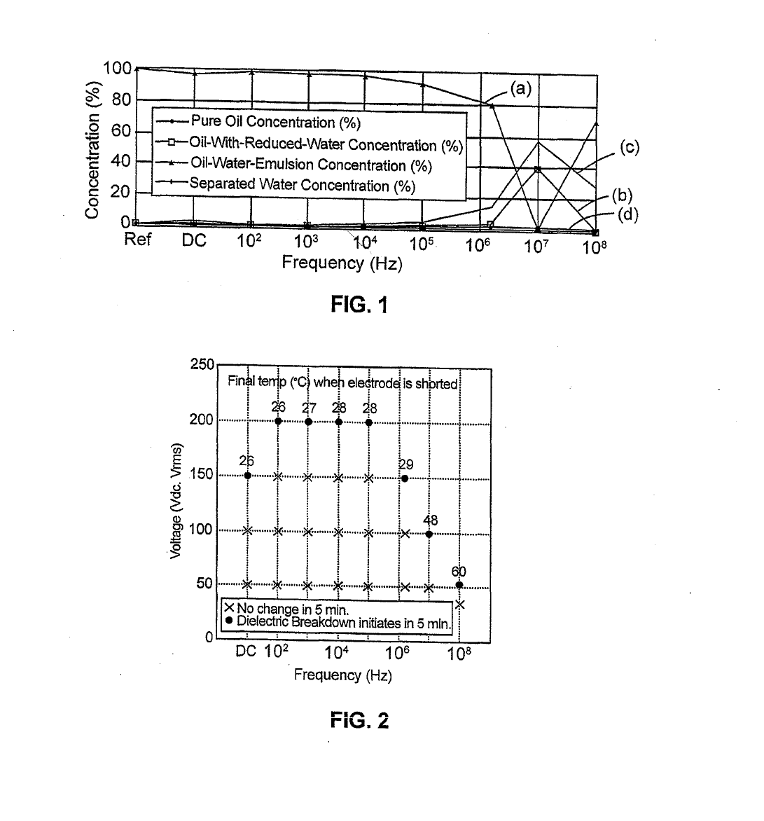

Quantitative analysis of the separated water and oil for crude oil emulsion system IC #2 in the vessel as a function of frequency is graphically illustrated in FIG. 1, wherein it may be observed that the three components, separated pure oil (curve a), separated water (curve b), and separated oil with reduced water (curve c) are maximized, and the concentration of the unseparated oil-water emulsion (curve d) is minimized, at a frequency of ˜10 MHz. The Reference sample (Ref) location on the abscissa represents the situation where no electric field is applied to the sample.

Also, in the stationary mode for the EFIS process, when the applied voltage is increased gradually the separation initiates abruptly at a specific voltage level, progresses rapidly, and then saturates. The saturation levels of both separated oil and separated water, along with the heat generated during the process depend strongly on the frequency. FIG. 2 shows this dependence on the IC #2 crude oil emulsion. Unlike the existence of an optimal frequency for separation products, the dielectric breakdown voltage level and the amount of heat generation do not show an optimal frequency; the breakdown voltage decreases monotonically, and the temperature of the crude system increases monotonically with increasing frequency above 100 kHz. It may be observed from FIG. 2 that separation initiates at about 200 Vᵣₘₛ between 100 Hz and 0.1 MHz, while the temperature rise is minimal. From 0.1 to 100 MHz, the breakdown voltage decreases from˜200 to˜50 Vᵣₘₛ, whereas the final temperature when the electrode is shorted increases from 28° C. to 60° C. Thus the separation efficiency and the voltage requirement and acceptable temperature rise must be considered for an effective EFIS process.

In the stationary mode, the EFIS process may saturate before a high level of water-oil separation occurs as a result of the formation of low-resistance/low-impedance shorting paths within the emulsion system. As will be discussed in more detail hereinbelow, the use of insulated electrodes for AC excitation may improve the shorting path tolerance of, and limit current flow in the separation process, and consequently lead to saturation of the process at a higher separation level. By removing separated conductive components, which in many situations principally comprise brine from the high electric field region of the EFIS vessel in a flow mode, this limitation may be eliminated. Additionally, by stirring the crude oil in the vessel, conducting channels may be broken, and further coalescence and settling of water droplets may be assisted when the stationary mode process saturates.

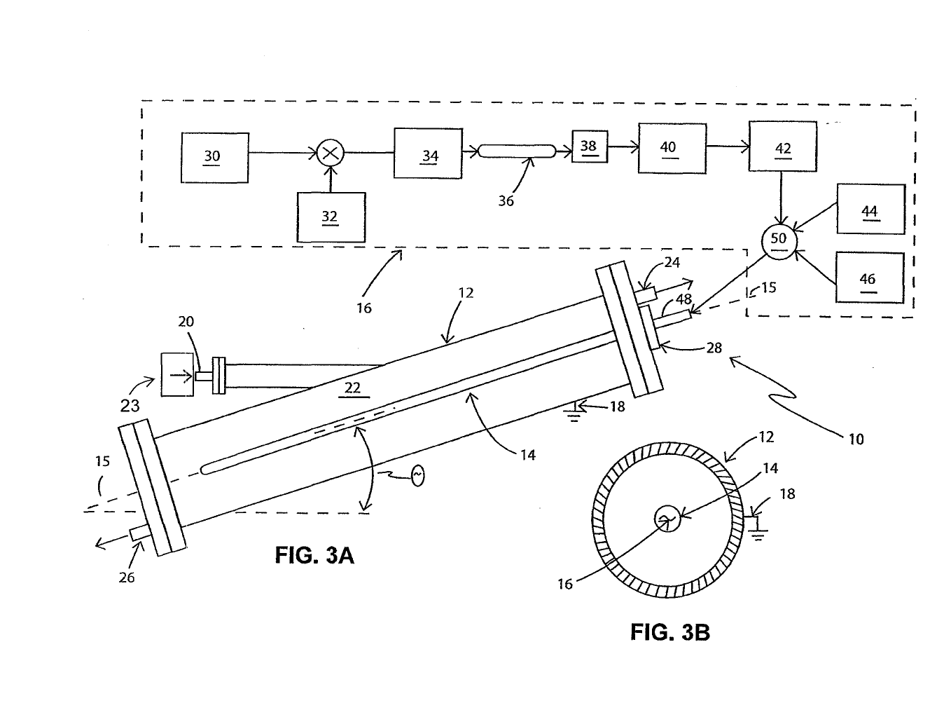

Reference will now be made in detail to the present embodiments of the invention, examples of which are illustrated in the accompanying drawings. In the FIGURES, similar structure will be identified using identical reference characters. It will be understood that the FIGURES are presented for the purpose of describing particular embodiments of the invention and are not intended to limit the invention thereto. Turning now to FIG. 3, FIG. 3A is a schematic representation of a side view of one embodiment of the apparatus, 10, of the present invention is shown, illustrating an embodiment of hollow cylindrical vessel or chamber, 12, having a single, central electrode, 14, collinearly disposed to cylindrical axis, 15, for generating electric field induced separation and electronic apparatus, 16, for supplying dc and high-frequency voltages to chamber 12 and for diagnostic analyses of the voltages and currents thereof. FIG. 3B is a schematic representation of a top cross sectional view of the apparatus of FIG. 3A, illustrating vessel 12 and central electrode 14. Chamber 12 may be constructed from electrically conductive material, and is electrically grounded, 18, to provide a current path for the electrical energy provided by electronic apparatus 16. If non-conducting vessels are required, a grounded cage structure inside the vessel may be employed.

Hollow cylindrical vessel 12 is shown having fluid inlet, 20, through which fluid may be pumped into internal volume, 22, by pump, 23, and means for removing separated fluids through fluid exits, 24, and 26, therefrom. One means for removing separated fluids from chamber 12, in the situation where the fluid comprises a crude oil/water suspension and the oil phase is lighter than the water phase, includes oil and oil/water emulsion flowing out of fluid exit 24, and separated water flowing out of fluid exit 26. The inlet and outlet ports would generally have valves and other plumbing for controlling pressures and flow rates, which are not shown in the FIGURES. Chamber 12 may be tilted by chosen angle θ relative to the horizontal plane.

Electrode 14 is shown as being supported by electrically insulated feed-through, 28, and attached to electronic apparatus 16. Electronic apparatus 16 may include: tunable, broadband high-frequency signal source; 30, sweep modulator, 32, for modulating the output for signal source 30; broadband amplifier, 34; transmission line, 36; protective circuitry, such as a circulator, 38; voltage step-up circuitry, 40; impedance matching circuitry, 42; diagnostic probes, 44, for measurement of voltage, current, phase, etc.; and dc voltage source, 46, for providing a dc bias voltage in addition to the high-frequency voltage from source 30. Voltage is applied to external portion, 48, of electrode 14 through bus, 50.

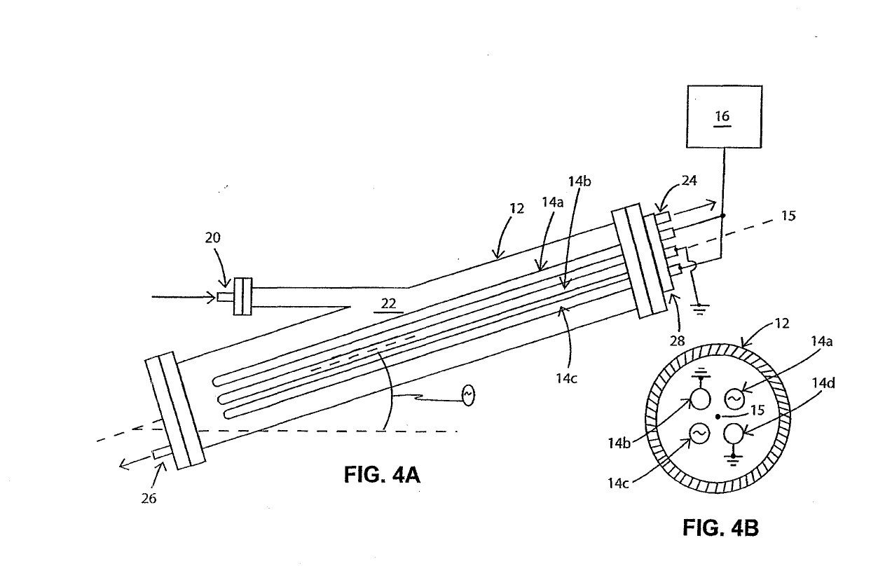

FIG. 4A is a schematic representation of a side view of a multielectrode embodiment of apparatus 10 shown in FIG. 3A, wherein parallel internal electrodes 14a-14d are disposed parallel to axis 15 of hollow cylindrical chamber 12, while FIG. 4B is a schematic representation of a top cross sectional view thereof. In this configuration, vessel 12 may or may not be grounded.

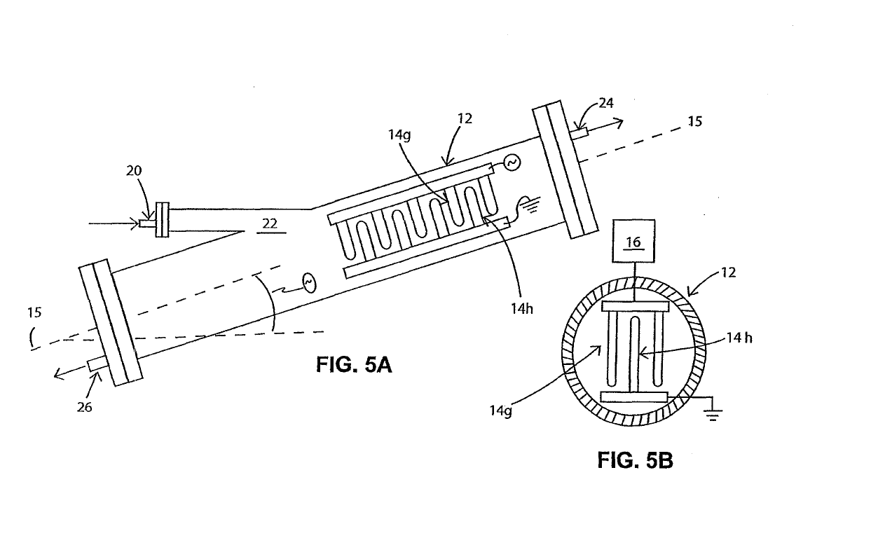

FIG. 5A is a schematic representation of a side view of another multielectrode embodiment of apparatus 10 shown in FIG. 3A, wherein powered internal electrodes, 14g, and grounded internal electrodes, 14h, are disposed perpendicularly to axis 15 of hollow cylindrical vessel 12, while FIG. 5B is a schematic representation of a top cross sectional view thereof.

The embodiments shown in FIGS. 3 to 5 may all provide high electric fields, and high electric field gradients. By contrast, a parallel plate electrode configuration may provide a high electric field, but only a small electric field gradient, except near the edges of the plates. Typical operating frequency ranges include DC to about 1 GHz; typical electric fields may range between about 0.01 and approximately 100 kV/cm; typical electric field gradients may be between about 0.01 and approximately 10³ kV/cm²; sweep frequencies may range between DC and about 1 GHz; and any modulation frequency and waveform including FM. Typical separation durations range between milliseconds and kilo seconds, and temperatures may include ambient temperature to about 150° C. As will be discussed in more detail hereinbelow, the high-frequency electric field may be offset by a chosen dc voltage. For a given flow rate, the effective length of the apparatus determines the length of time the separation process is continued.

Having generally described the present invention, the following EXAMPLES provide additional details.

### EXAMPLE 1

### Batch Mode:

To study the effectiveness of EFIS for oil-water separation without the limitations caused by shorting paths in the stationary mode, a batch mode EFIS process including a combination of stationary mode voltage application with mechanical stirring, has been implemented. The cell employed was similar to the cell described in FIGS. 3A and 3B, hereof, having a single electrode (1 mm diameter×76 mm length), a 15 cm³ volume and an inner diameter of 16 mm. The cell was horizontally disposed (θ=0° ). A sequential combination of stationary mode voltage application and stirring was repeated till water concentration in the separated oil was less than 4% by weight. TABLE 1 summarizes the results for the crude oil system IC #2, for the water droplet size distribution (given by count ratio of different diameter water droplets) and for the water concentration in separated oil, after an EFIS separation process at different frequencies.

TABLE 1

| | | | Count Ratio | Count Ratio | |
|---|---|---|---|---|---|
| Sample | Freq. | | (0.5 μm/1 μm) | (1 μm/2 μm) | Water Conc. |
| A1 | 2 | MHz | 1.2 | 3.3 | 2.7% |
| A2 | 3 | MHz | 1.5 | 9.3 | 2.6% |
| A3 | 5 | MHz | 2.0 | 4 | 2.2% |
| A4 | 1.6 | MHz | 2.3 | 5.5 | 2.6% |
| A5 | 10 | kHz | 1.4 | 4.4 | 3.6% |
| A6 | 2 + 3 | MHz | 2.2 | 10.6 | 1.2% |
| A7 | 1 | kHz | 1.3 | 6.3 | 1.6% |
| A8 | 100 | kHz | 1.7 | 13.5 | 1.9% |

In TABLE 1, the size distribution of water droplets in separated oil was determined by optical microscopy image processing (with a lower bound of 0.5 μm diameter), whereas the water concentration in separated oil was determined by Karl-Fischer titration. The Count Ratio (x/y) in TABLE 1 refers to the ratio of the number of water droplets with diameter x and diameter y. The water concentrations listed in TABLE 1 show that one can achieve more than ten-fold reduction in water concentration (from 65% to less than 4% water) at any frequency investigated between 1 kHz and 5 MHz as long as a method is used to remove/break shorting paths in the emulsion system (in this case, the method employed being mechanical stirring). In general, the water droplet size is reduced with decreasing water concentration, the largest reduction in overall water droplet size (given by count ratio of 0.5-μm-diameter/2-μm-diameter) with EFIS being achieved between 100 kHz and 3 MHz. Further, using two frequencies (2 MHz and 3 MHz) yields the lowest water concentration, and the smallest water droplet size in the separated oil. The water droplet size distribution has also been examined using dynamic light scattering (DLS) spectroscopy. DLS results indicate that the water droplet size distribution is approximately log-normal, and that the mean diameter is reduced from ˜1 μm to ˜0.5 μm with EFIS processing when the water content is reduced from ˜50% to ˜1%. Thus, by contrast optical microscopic analysis permits the investigation of the large-diameter tail of the water droplet size distribution.

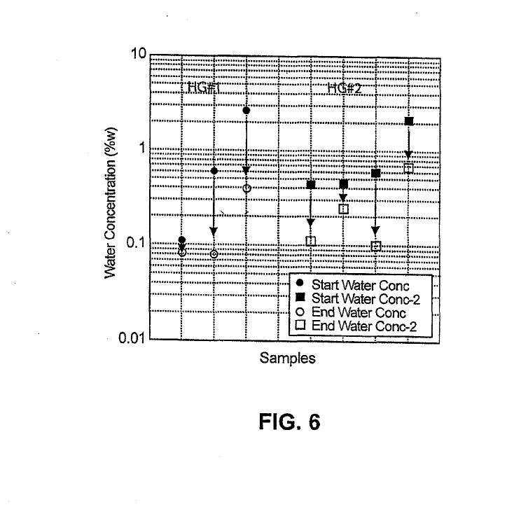

The present EFIS process may also yield significant reduction of water concentration in low water-cut crude oil emulsion systems. FIG. 6 shows the results of EFIS processing for two crude oil systems having less than 3% water, HG#1 (API gravity of separated oil=51° , water cut=0.1% -2.8% (>95% oil; and <2% solids)) and HG#2 (API gravity of separated oil=51° , water cut=0.4%−2.1% (>95% oil; and <2% solids)). Independent of the initial water concentration, the EFIS process is seen to reduce the water concentration in separated oil by a factor of 2 to 8, where the same voltage, frequency, and duration were used for each sample. It has been observed that the higher the initial water cut, the larger the reduction, and that increasing the voltage, increases the water reduction in the separated oil; that is, the saturation level for water content in the separated oil decreases.

### EXAMPLE 2

### Flow Mode:

The EFIS may also be used in a flowing system. Two bench-top cells were constructed to permit EFIS processing at ˜1 mL/min flow rate and at ˜100 mL/min (or, ˜1 bbl/day). The cells employed were similar to the cell described in FIGS. 3A and 3B, hereof, having a single electrode (1 mm diameter×76 mm length), a 15 cm³ volume and an inner diameter of 16 mm, for the small cell, and a single electrode (1 mm diameter×125 mm length), a 120 cm³ volume and an inner diameter of 35 mm, for the large cell. Both cells were horizontally disposed (θ=0° ). Separations for crude oil samples IC #1 (55% water; 43% oil; and 25 solids) and IC #2 (68% water; 30% oil; and 2% solids), for a one-pass continuous EFIS process are summarized in TABLE 2.

TABLE 2

| | | | Water | Water | | Electric |
|---|---|---|---|---|---|---|
| Flow | Flow | Crude | Conc. | Conc. | Heat | Power |
| Cell | Rate | Oil | (before) | (after) | Generated | Consumed |
| Small | 1 mL/min | IC#1 | 55% | 3.1% | — | — |
| Large | 100 mL/min | IC#2 | 68% | 7.3% | 18 W | 168 W |

The small flow cell exhibited reduction of water for IC #1 from 55% to 3.1% with a single pass at a rate of ˜1 mL/min. The large flow cell incorporated diagnostic probes for monitoring electric energy input into the EFIS set-up as well as in-flow temperature sensors for monitoring heat generation in the vessel. Reduction of water concentration from 68% to 7% was observed for IC #2 in a single pass at a rate of ˜0.1 L/min (or, ˜1 bbl/day) with ˜18 W of heat generation and ˜168 W of input electrical power. The discrepancy between thermal and electrical power may be due to non-optimized coupling of electrical energy from the power amplifier to the crude oil, leading to excessive energy losses in cables, transformers, and connectors. The measured thermal and electrical power figures provide lower and upper bounds, respectively, for the EFIS process, yielding energy/power requirements for oil-water separations (with about 10-fold water concentration reduction) of˜10-100 MJ/m³ of separated-water, or ˜10-100 kW for 10³ bbl/day crude processing.

In addition to water, the EFIS process reduces the concentration of many other impurities present in crude oil. TABLE 3 lists concentration reductions for impurities in separated water and separated oil after the first pass and the second pass EFIS processing using the small flow cell for IC #1. The water concentrations were measured by Karl-Fischer titration, whereas elemental impurity concentrations were determined by inductively couple plasma (ICP) spectroscopy.

TABLE 3

| | | | | Separated |
|---|---|---|---|---|
| | Crude Oil - | Separated Oil | Separated Oil | Water |
| Species | IC#1 (as is) | (1^{st} pass) | (2^{nd} pass) | (1^{st} Pass) |
| Water | 55% | 3.1% | 1.2% | — |
| Iron | 68 ppm | 18 ppm | 15 ppm | 7 ppm |
| Tin | 19 | 6 | 0 | 52 |
| Aluminum | 24 | 4 | 0 | 15 |
| Silicon | 51 | 8 | 4 | 31 |
| Potassium | 84 | 13 | 18 | 54 |
| Sodium | 5116 | 352 | 14 | 4997 |
| Boron | 33 | 1 | 0 | 56 |
| Magnesium | 25 | 8 | 6 | 10 |
| Calcium | 82 | 24 | 13 | 3 |

TABLE 3 shows that in EFIS separated oil impurity levels of Tin, Aluminum, Silicon, Sodium, Boron are significantly reduced, whereas impurity levels of Iron, Potassium, Magnesium, and Calcium are moderately reduced.

### EXAMPLE 3

### Heavy Crude:

One gallon of crude oil (API gravity of 13°; 0.979 g/cm³; <2% water) was homogenized with about 8 wt. % of produced water at 5,000 rpm for 5 min. using a high-shear blender in three, approximately 1.3 L batches. It was found that the water content was reduced to 2.7% at 80° C. in a heated EFIS vessel having a flow rate of 0.50 BPD, with 160 W of RF power at 6 MHz (8.6 kWh/bbl). The cell employed was similar to that described in FIGS. 3A and 3B, hereof, had a single electrode (1 mm diameter×500 mm length), a 500 cm³ volume and an inner diameter of 35 mm. The cell was disposed at θ=45°. Water content was measured using Karl-Fischer titrations.

Further investigation of the EFIS process has yielded the following properties:
(1) Insulation of the electrodes was found to protect against runaway current flow. However, larger voltages are required to initiate separation for both high electric field gradient configurations and low electric field gradient configurations, especially at lower frequencies.
(2) Breakdown voltages are lower at higher frequencies both for insulated and non-insulated electrodes; however, the exact frequency at which this occurs depends on the crude oil system.
(3) High electric field gradients lower the breakdown voltages for a given electrode separation.
(4) Higher voltages reduce the time for a given separation.
(5) Joint application of DC and RF electric fields increases the separation yields over those for DC alone. In one situation, the separation was increased three-fold.
(6) Joint application of DC and RF electric fields reduces the dielectric breakdown voltage. In one situation, the breakdown voltage was reduced by a factor of 3.
(7) Time gating has been found to increase the dielectric breakdown voltage, and reduce the temperature rise.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. Apparatus for separating water from oil in an emulsion thereof, comprising: a chamber for receiving the emulsion having an inlet port for introducing said emulsion, at least one first exit port for extracting separated oil and oil/water emulsion, and at least one second exit port for extracting separated water; at least one first electrode disposed within said chamber and in contact with said emulsion; at least one grounded, second electrode disposed within said vessel and in contact with said emulsion; at least one first voltage source for generating a selected voltage having a chosen frequency in electrical communication with said at least one first electrode for producing dielectric breakdown of said emulsion; whereby a chosen electric field distribution and a chosen electric field gradient distribution are established between said at least one first electrode and said at least one second electrode effective for achieving water separation from said emulsion.

2. The apparatus of claim 1, further comprising a second voltage source for providing a dc bias to said at least one first electrode.

3. The apparatus of claim 1, wherein said at least one first electrode is electrically insulated by a dielectric material.

4. The apparatus of claim 1, wherein said chamber is electrically conducting, and said at least one grounded, second electrode is placed in electrical communication with said chamber.

5. The apparatus of claim 1, wherein said at least one voltage source comprises a tunable, broadband frequency voltage source.

6. The apparatus of claim 5, wherein the chosen frequency is between approximately 100 Hz and approximately 1 GHz.

7. The apparatus of claim 1, further comprising a first voltage source and a third voltage source for generating a first chosen frequency and a second chosen frequency.

8. The apparatus of claim 1, further comprising electronic measurement apparatus for measuring voltage between said at least one first electrode and said at least one second electrode, and current flowing between said at least one first electrode and said at least one second electrode, whereby an electrical short therebetween is detected.

9. The apparatus of claim 1, further comprising electronic apparatus for measuring temperature of said emulsion.

10. The apparatus of claim 9, wherein the temperature is kept to < about 150° C.

11. The apparatus of claim 1, further comprising a pump for flowing said emulsion into the inlet port of said chamber.

12. The apparatus of claim 1, wherein said chamber is oriented such that separated oil and oil/water emulsion flows out of the at least one first exit port, and separated water flows out of the at least one second exit port.

13. The apparatus of claim 1, wherein the chosen electric field distribution is between about 0.01 kV/cm and about 100 kV/cm, and the chosen electric field gradient distribution is between approximately 0.01 kV/cm² and approximately 10³ kV/cm².

14. Method for separating water from oil in an emulsion thereof, comprising:
introducing the emulsion into a chamber enclosing at least one pair of electrodes in contact with the emulsion, and having at least one port for introducing oil/water emulsion, at least one port for removing separated water, and at least one port for removing separated oil and oil/water emulsion; applying a selected voltage at a chosen frequency between each pair of the at least one pair of electrodes such that a chosen electric field and electric field gradient effective for producing dielectric breakdown in said emulsion is produced; whereby water is separated from the oil in the emulsion; and removing the separated water and the separated oil and oil/water emulsion from the chamber.

15. The method of claim 14, further comprising the step of providing a dc bias between each pair of the at least one pair of electrodes.

16. The method of claim 14, wherein one electrode of each pair of the at least one pair of electrodes is grounded.

17. The method of claim 16, wherein the chamber is electrically conducting, and the grounded electrode of each pair of the at least one pair of electrodes is placed in electrical communication with the chamber.

18. The method of claim 14, wherein at least one electrode of each pair of the at least one pair of electrodes is electrically insulated by a dielectric material.

19. The method of claim 14, wherein said step of applying a selected voltage at a chosen frequency between each pair of the at least one pair of electrodes further comprises applying a tunable, broadband frequency voltage between each pair of the at least one pair of electrodes.

20. The method of claim 19, wherein the chosen frequency is between approximately 100 Hz and approximately 1 GHz.

21. The method of claim 14, further comprising the step of applying a second selected voltage at a second chosen frequency between each pair of the at least one pair of electrodes.

22. The method of claim 14, further comprising the steps of measuring the voltage between each pair of the at least one pair of electrodes; and measuring the current flowing between the electrodes of each pair of the at least one pair of electrodes, whereby an electrical short therebetween is detected.

23. The method of claim 14, further comprising the step of measuring the temperature of the emulsion.

24. The method of claim 23, wherein the temperature is kept to < about 150° C.

25. The method of claim 14, further comprising the step of flowing the emulsion into the chamber.

26. The method of claim 14, wherein the chamber is oriented such that said step of removing the separated water and the separated oil from the chamber comprises permitting separated oil to flow out of the at least one port for removing oil, and the at least one port for removing water.

27. The method of claim 14, wherein the chosen electric field distribution is between about 0.01 kV/cm and about 100 kV/cm, and the chosen electric field gradient distribution is between approximately 0.01 kV/cm² and approximately 10³ kV/cm².

28. The method of claim 14, further including the step of analyzing the separated oil from said step of removing the separated water and the separated oil and oil/water emulsion from the chamber.
